(19) United States
(12) Patent Application Publication
(10) Pub. No.: US 2010/0228701 A1
(43) Pub. Date: Sep. 9, 2010

(54) UPDATING BLOOM FILTERS

(75) Inventors: Ralph Burton Harris, III, Woodinville, WA (US); Amit Jhawar, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/399,445

(22) Filed: Mar. 6, 2009

(51) Int. Cl. G06F 17/30; G06F 12/10

(52) U.S. Cl. 707/683; 711/117; 707/E17.005; 709/206; 709/231; 707/E17.01; 711/E12.06; 711/216; 707/609

(57) ABSTRACT

The present invention extends to methods, systems, and computer program products for updating Bloom filters. Embodiments of the invention facilitate more efficient use Bloom filters across multiple computers connected across a WAN (potentially having limited bandwidth and latency characteristics), such as, for example, computers located on different continents. The acceptability of false positives is leveraged by allowing the operation of removing items from a set to be batched and delayed. On the other hand, insert operations may be more latency sensitive as a delayed insert results in the semantic equivalent to a false negative. As such, additions to a set are processed in closer to real time to update Bloom filters. In some embodiments, Bloom filters are used to check set membership for electronic mail addresses.

### CROSS-REFERENCE TO RELATED APPLICATIONS

Not Applicable.

### BACKGROUND

1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, electronic messaging, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

In many computing environments, it is desirable to perform digital filtering operations. Sometimes digital filter operations, such as, for example, set-membership lookups against a plurality of character strings, need to be performed in essentially real time. For example, upon receiving an electronic mail message, electronic mail providers can do set-membership look ups against received electronic mail addresses to determine if received electronic mail addresses correspond to valid accounts for the electronic mail provider. When an electronic mail address corresponds to a valid account, the electronic mail provider can perform further processing (e.g., virus scanning, SPAM detection, etc) the electronic message before delivery. On the other hand, when an electronic mail address does not correspond to a valid account, the electronic mail provider does not waste resources on further processing.

These types of electronic mail lookups are typically performed using the Lightweight Direction Access Protocol (“LDAP”). However, this approach causes an electronic mail server to do multiple network round trips to an LDAP server for message recipient thereby reducing throughput.

Bloom filters provide an alternate solution to such lookups. Bloom filters are in-memory data structures that can be used for in-memory lookups of electronic mail addresses. A bloom filter represents set membership probabilistically as multiple bits scattered across a larger bit map. Hash functions are used to scatter the bits within the larger bit map. A number of hash functions equal to the number of scattered bits is used. For example, to scatter bits at 16 different locations within a larger bit map, 16 different corresponding hash functions can be used.

Using a Bloom filter “false negatives” are not possible. That is, a bloom filter essentially can not indicate that a string is not a member of a set when it really is a member of the set. On the other, hand bloom filters have a predictable “false positive” rate. That is, in some instances a bloom filter can indicate that a string is a member of a set when it really is not a member of the set. However, the “false positive” rate is controllable (but not eliminated) by properly sizing a bit map and number of hash functions

However, due to the possibility of hash collisions, individual entries for a set can not be removed from a Bloom filter without violating the no false negative behavior. That is, removing one entry from a Bloom filter may also inadvertently remove a bit (or possibly one or more bits) from the entries for one or more other members of the set. As such, any subsequent membership checks after removal can incorrectly indicate that data is not a member of the set when in fact it is a member of the set.

Thus, to appropriately represent the removal of entries from a set, a completely new Bloom filter has to be created and distributed out to multiple electronic mail servers. Depending on the number of electronic mail addresses in a set, the bloom filter can be quite large, on the order of hundreds of megabytes. Distributing updates to a file of this size consumes a large amount of network bandwidth, potentially negatively impacting electronic message and other processing performance at an electronic mail provider.

### BRIEF SUMMARY

The present invention extends to methods, systems, and computer program products for updating bloom filters. A computer system receives an update to a set. The set update changing membership in the set. The computer system determines if the set update represents insertion of a new resource into the set or deletion of an existing resource from the set.

When the set update represents insertion of a new resource into the set, the computer system inserts the new resource into the set. The computer system also supplements a local version of the bloom filter in system memory to represent that the new resource is a member of the set. The computer system also sends data indicative of the set update to each of one or more other computer systems separate from the bloom filter and before a new version of the bloom filter including the set update is generated. The data indicative of the set update is for supplementing local versions of the bloom filter at the one or more other computer systems. Accordingly, the one or more other computer systems can individually supplement their local versions of the bloom filter to represent insertion of the new resource without having to receive a new version of the bloom filter.

On the other hand, when the set update represents deletion of an existing resource from the set, the computer system queues the set update for inclusion in a next new version of the bloom filter that is generated

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates updating a bloom filter.

FIG. 2 illustrates an example computer architecture that facilities updating a bloom filter used for checking electronic mail addresses.

FIG. 3 illustrates a flow chart of an example method for updating a bloom filter.

FIG. 4 depicts an example of using a Bloom filter to check set membership.

### DETAILED DESCRIPTION

The present invention extends to methods, systems, and computer program products for updating bloom filters. A computer system receives an update to a set. The set update changing membership in the set. The computer system determines if the set update represents insertion of a new resource into the set or deletion of an existing resource from the set.

When the set update represents insertion of a new resource into the set, the computer system inserts the new resource into the set. The computer system also supplements a local version of the bloom filter in system memory to represent that the new resource is a member of the set. The computer system also sends data indicative of the set update to each of one or more other computer systems separate from the bloom filter and before a new version of the bloom filter including the set update is generated. The data indicative of the set update is for supplementing local versions of the bloom filter at the one or more other computer systems. Accordingly, the one or more other computer systems can individually supplement their local versions of the bloom filter to represent insertion of the new resource without having to receive a new version of the bloom filter.

On the other hand, when the set update represents deletion of an existing resource from the set, the computer system queues the set update for inclusion in a next new version of the bloom filter that is generated

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

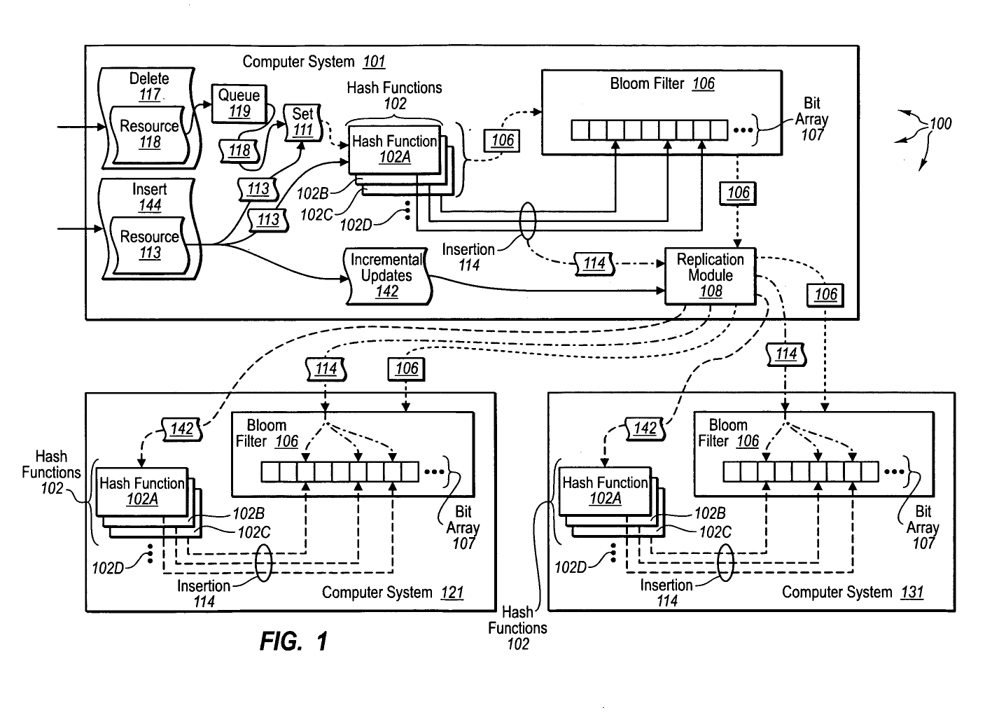

FIG. 1 illustrates an example computer architecture 100 that facilitates updating a bloom filter. Referring to FIG. 1, computer architecture 100 includes computer systems 101, 121, and 131. Each of computer systems 101, 121, and 131 is connected to one another over (or is part of) a network, such as, for example, a Local Area Network (“LAN”), a Wide Area Network (“WAN”), and even the Internet. Accordingly, each of computer systems 101, 121, and 131 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Computer system 101 can be a primary or “main” computer system that an administrator or user interacts with more directly, such as, for example, through a user interface, to update sets. Thus, a user of computer system 101 can interact with computer system 101 to add resources to and delete resources from sets (e.g., set 111). Queue 119 is configured to queue set updates until they are implemented into a corresponding set.

Hash functions 102 includes a plurality of hash functions include has functions 102A, 102B, 102C, etc. Ellipsis 102D represents that one or more other has functions can be included in hash functions 102. Generally, a hash function is a mathematical function which converts a larger, possibly variable-sized amount of data into a smaller datum. The smaller datum can serve as an index into an array. For example, a hash function can be configured to converting a variable sized string into an integer. The integer can represent a location in a bit array. A value returned by a hash function can be referred to as a hash value, hash code, or simply a hash. Thus, each of hash functions 102 can be configured to receive a resource (e.g., a string) and process the resource to generate a number (integer) representing a location within a bit away. Hash functions are configured to generate the same hash value from the same input data. That is, each time the same input data is processed the same hash value is generated.

Accordingly, to create a Bloom filter entry for a resource, the resource is run through each active hash function to generate a hash value indicating a bit array location. For example, if ten hash functions are being used, ten bit array locations are generated. The value at each bit array location is set to indicate that a hash function generated a number representing the location. For example, if a hash function generates a hash value of 27, the 27^{th} bit location in a bit array can be set to a non-initialized value. In some embodiments, this can include toggling the value at a bit location from an initialized value of “0” to “1”. However, hash collisions can also cause a value already set to “1” to again be set to “1”. To create a Bloom filter representative of the entire membership of a set, each resource in the set is run through each active hash function to generate hash values indentifying bit array locations.

For larger sets, the number of utilized hash functions and/or the size of a bit array can be increased. On the other hand, for smaller sets the number of utilized hash functions and/or size of a bit array can be decreased. The number of hash functions used and/or the size of a bit array can be configured based the application, administrative settings, balancing consumed resources against a rate of false positives, or other settings.

Generally, the probability of false positives for a Bloom filter decreases as the number of bits (m) in the bit array is increased. On the other hand, the probability of false positives for a Bloom filter increases as the number of elements inserted (n) in bit array increases. After inserting n keys into a table of size m, the probability that a particular bit is still zero is:

(1−(1/m))^{kn}

where k is the number of hash functions.

Hence the probability of a false positive in this situation is:

(1−(1−(1/m)^{kn})^{k}˜(1−e^{kn/m})^{k}

(1−e^{kn/m})^{k} is minimized for k=ln 2 (m/n), in which case it becomes:

(1/2)^{k}˜(0.6185)^{n/m}

As such, an add to a Bloom filter can not fail due to the Bloom filter “filling up”. However, the false positive rate can increase as resources are processed. In practice k is an integer. A less than optimal k value can be selected to reduce computational overhead. Nonetheless, except for relatively small (m/n) ratios (indicating a heavily populated bit array) combined with a relative small number of hash values, the probability of false positives is less than 0.01. For example, an (m/n) ratio of 10 (e.g., ten entries in a 100-bit bit field) and k=8 results in a false positive probability of approximately 0.00846

Replication module 108 is configured to replicate data to other computer systems including computer systems 121 and 131. For example, replication module 108 can replicate bloom filter 106 created at computer system 101 to computer systems 121 and 131. Replication module 108 can also replicate incremental updates to a set and/or bit array locations within a bit array to computer systems 121 and 131.

Computer systems 121 and 131 also include hash functions 102. As such, computer systems 121 and 131 can generate bloom filter entries mirroring those generated at computer system 101.

In some embodiments, a Bloom filter is used for efficiently determining set membership. For example, Bloom filter 106 can be initialized and loaded into system memory of computer system 101 for use in determining set membership in set 111. Bloom filter 106 includes bit array 107. Upon loading Bloom filter 106, the values in bit array 107 can be set to the same initialization value, such as, for example, “0”.

Hash functions 102 can process resources in set 111 to populate bit array 107. For example, for each resource in set 111, k hash functions included in hash functions 102 can generate hash values identifying bit locations within bit array 107, resulting in k bit locations per resource. For each resource, each of the identified k bit locations in bit array 107 can be set to its uninitialized value, such as, for example, 1 (e.g., either from “0” to “1” or on a collision from “1” to “1”).

After each resource in set 111 is processed, Bloom filter 106 can be used to process queries to determine if a resource is or is not a member of set 111. When a query is received, hash functions 102 can process a resource to generate hash values identifying k bit locations. The k bit locations are checked and if each bit location includes a non-initialized value (e.g., a “1”), the resource is identified as matching a member of set 111. This is determined to be a match since the processing of resources in set 111 resulted in bits at these k identified locations being set. Further, although not guaranteed due to the possible of a false positives, its is most likely a match due to processing of a single resource in set 111 resulting in bits at these k identified locations being set. Thus, the resource is likely is an exact match to a resource contained in set 111. Upon detecting a match in bit array 107, computer system 101 can determine that a resource received in a query is a member of set 111.

Subsequent to generation of bloom filter 106, computer system 101 can receive set updates, such as, for example, delete 117 and/or insert 144, to set 111. Set updates can be processed to update bloom filter 106.

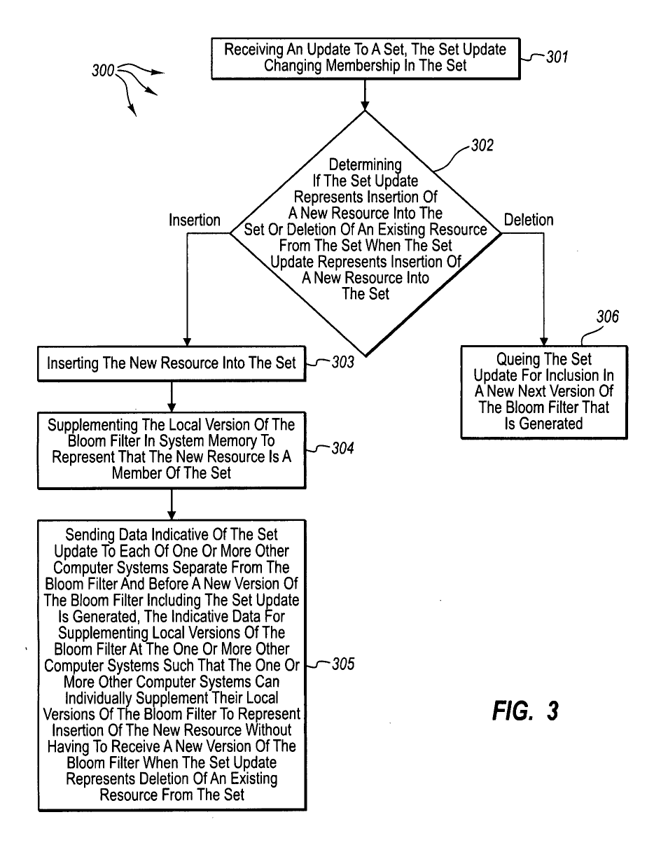

FIG. 3 illustrates a flow chart of an example method 200 for updating a bloom filter. Method 300 will be described with respect to the components and data of computer architecture 100.

Method 300 includes an act of receiving an update to a set, the set update changing membership in the set (act 301). For example, computer system 100 can receive either of delete 117 or insert 144 to set 111.

Method 300 includes an act of determining if the set update represents insertion of a new resource into the set or deletion of an existing resource from the set (act 302). For example, computer system 101 can determine if a received update represents insertion of a new resource into set 111 or deletion of an existing resource of from set 111. Upon receiving insert 144, computer system 101 can determine that insert 144 is a request to insert resource 113 into set 111.

When the set update represents insertion of a new resource into the set (Insertion at 302), method 300 includes an act of inserting the new resource into the set (act 303). For example, computer system 101 can insert resource 113 into set 111. When the set update represents insertion of a new resource into the set (Insertion at 302), method 300 also includes an act of supplementing the local version of the bloom filter in system memory to represent that the new resource is a member of the set (act 304). For example, computer system 101 can pass resource 113 to hash functions 102. The same hash functions used when populating bit array 107 can be used to process resource 113. The result of processing resource 113 can be insertion 114, which indentifies k bit locations to set in bit array 107. The k bit locations of insertion 114 can be set in bit array 107 to add an entry for resource 113 to bloom filter 106.

When the set update represents insertion of a new resource into the set (Insertion at 302), method 300 also includes sending data indicative of the set update to each of one or more other computer systems separate from the bloom filter and before a new version of the bloom filter including the set update is generated, the set update for supplementing local versions of the bloom filter at the one or more other computer systems such that the one or more other computer systems can individually supplement their local versions of the bloom filter to represent insertion of the new resource without having to receive a new version of the bloom filter (act 305). Sending data indicative of set update can include sending a file indicative of a set update or sending a data or file stream indicative of a set update to other computer systems. For example, replication module 108 can replicate insertion 114 at one or both of computer systems 121 and 131. Replicating insertion 114 at computer systems 121 and 131 causes the versions of bloom filter 106 at computer systems 121 and 131 to mirror the version of bloom filter 106 at computer system 101.

Alternately, in combination with generation insertion 114, computer system 101 can sent incremental updates 142, including insert 144, to replication module 108. Replication module 108 can then replicate incremental updates 142 are computer systems 121 and 131. Hash functions 102 at computer systems 131 and 131 can process incremental updates 142 to regenerate insertion 114 for insert 144. Computer systems 121 and 131 can then perform insertion 114 to cause the versions of bloom filter 106 at computer systems 121 and 131 to mirror the version of bloom filter 106 at computer system 101.

In either event, computer systems 121 and 131 can individually supplement their local versions of bloom filter 106 to represent insertion of resource 113 resource without having to receive a new version of bloom filter 106. Accordingly, computer systems 121 and 111 can more accurately check membership in set 111 in response to receiving insert 144 at computer system 101. Further, the versions of Bloom filter 106 at computer systems 121 and 131 are efficiently updated without having to generate a new version of Bloom filter 106.

On the other hand, upon receiving delete 117, computer system 101 can determine that delete 117 is a request to delete resource 118 from set 111. When the set update represents deletion of an existing resource from the set (Deletion at 302), method 300 includes and act of queuing the set update for inclusion in a next version of the bloom filter that is generated (act 306). For example, computer system 101 can queue delete 117 in queue 119. From time to time, computer system 101 can implement deletions queued in queue 119 into set 111. For example, queued deletions can be implemented in preparation for generating a new version of a Bloom filter for set 111.

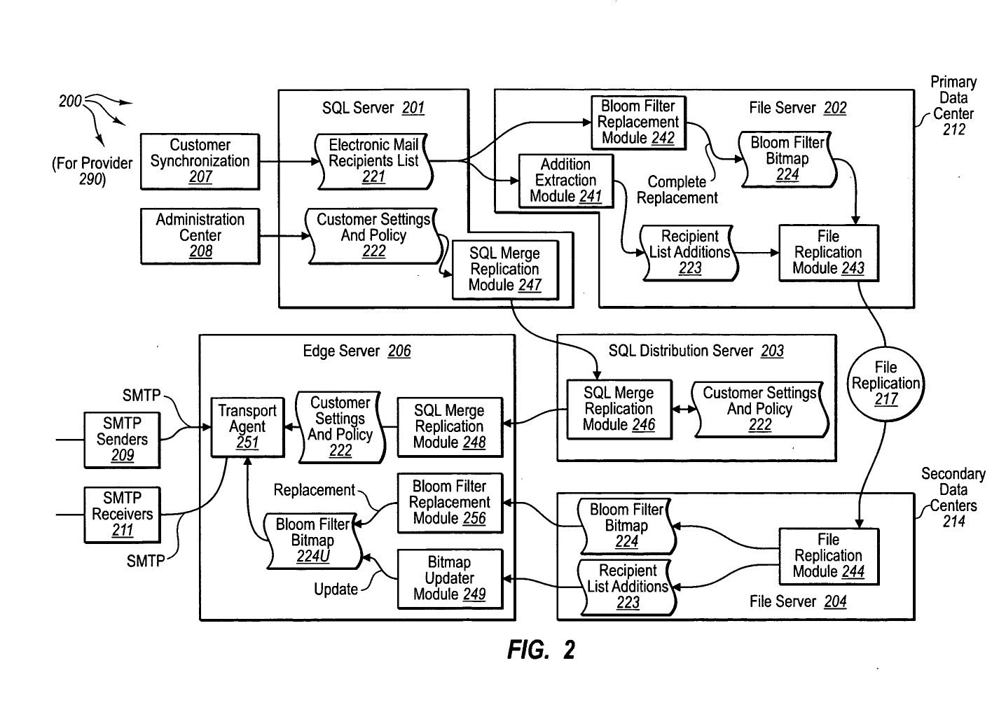

FIG. 2 illustrates example computer architecture 200 that facilities updating a bloom filter for checking electronic mail addresses for provider 290. Provider 290 can be an electronic mail provider that provides electronic mail services to users on a network (e.g., the Internet). Users can register with (and potentially submit payment to) provider 290 to establish an electronic mail account with provider 290. In response to establishing an account, provider 290 can assign an electronic mail address to a user. As such, the user can send electronic messages originating from the assigned electronic mail address. The users can also receive electronic messages at the assigned electronic mail address. For example, other users can generate electronic mail messages and include the assigned electronic mail address as a recipient electronic mail address in the generated electronic mail messages. When the generated electronic mail message is received at provider 290, provider 290 can determine that the electronic mail message is addressed to one of its assigned electronic mail address.

As depicted, computer architecture 200 includes SQL server 201, file server 202, SQL distribution server 203, file server 204, edge server 206, customizer synchronization 207, administration center 208, SMTP senders 209, and SMTP receivers 211. Each of SQL server 201, file server 202, SQL distribution server 203, file server 204, edge server 206, customizer synchronization 207, administration center 208, SMTP senders 209, and SMTP receivers 211 as well as any other connected computer systems and their components, can create message related data and exchange message related data with one another (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over a network.

As depicted, SQL server 201 includes SQL merge replication module 247. Further, SQL server 201 interacts with customer synchronization 207 and administration center 208. Customer synchronization 207 can provide SQL server 201 with electronic mail recipients list 221 (e.g., corresponding to users that have registered with provider 290). Electronic mail recipients list 221 includes a list of electronic mail addresses for which provider 290 provides electronic mail services. Administration center 208 can provide SQL server with customer settings & policy 222. Customer settings & policy 222 can indicate various settings for registered users, such as, for example, account type, inbox storage space, account duration, etc.

SQL merge replication module 247 can replicate customer settings & policy 222 to SQL distribution centers, such as, for example, SQL distribution server 203. For example, SQL merge replication module 247 and SQL merge replication module 246 can interoperate to replicate customer settings & policy 222 at SQL distribution server 203. SQL distribution servers can then replicate customer settings & policy 222 to edge servers (e.g., electronic mail servers) that process electronic mail messages. For example, SQL merge replication module 246 and SQL merge replication module 248 can interoperate to replicate customer settings & policy 222 at edge server 206.

SQL server 201 can pass electronic mail recipients list 221 to file server 202 in primary data center 212. As depicted, filer server 202 includes bloom filter replacement module 242, addition extraction module 241, and file replication module 243. From time to time, such as, for example, once a day, bloom filter replacement module 242 can generate a complete replacement of an existing bloom filter based on electronic mail recipient list 221. For example, bloom filter replacement module 242 can generate bloom filter 224. Primary data center 212 can then replicate bloom filter bitmap 224 to one or more secondary data centers. For example, file replication module 343 and file replication module 344 can interoperate using a file replication algorithm (e.g., Remote Differential Compression (“RDC”)) to replicate bloom filter bitmap 224 at secondary data server 214.

Addition extraction module 241 is configured to identify additions to an electronic mail recipients list. For example, addition extraction module 241 can identify recipient list additions 223 from electronic mail recipients list 221. To identify recipient list additions 223, addition extraction module 241 can compare electronic mail recipients list 221 to a prior version of electronic mail recipients list, such as, for example, a version of the electronic mail recipients list used to generate bloom filter bitmap 224. Thus, for example, recipient list additions 223 can include a list of electronic mail recipients added at SQL server 201 after the last complete replacement of a bloom filter at file server 202. Primary data center 212 can then replicate recipient list additions 223 to one or more secondary data centers. For example, file replication module 243 and file replication module 244 can interoperate using a file replication algorithm (e.g., (“RDC”)) to replicate recipient list additions at filter server at secondary data center 214.

Addition extraction module 241 can work with Bloom filter bitmap 224 to identify recipient list additions 223 before putting them in recipient list additions 223.

Further in addition to SQL server 201, bloom filter replacement module 242 and addition extraction module 241 can receive recipient data from other sources. For example, file server 202 can received recipient data using Secure File Transfer protocol (“SFTP”) or from a customer Lightweight Directory Access Protocol (“LDAP”) installation that is then dumped to file server 202.

Secondary data centers can send bloom filter bitmaps and recipient list additions to edge servers (e.g., electronic mail servers) that process electronic mail messages. For example, file server 204 can send bloom filter bit map 224 to bloom filter replacement module 256 and/or can send recipient list additions 223 to bitmap updater module 249 at edge server 306. When a completely new version of a bloom filter is received, bloom filter replacement module 246 can replace an existing version of a bloom filter. For example, bloom filter replacement module 256 can replace an existing version of a bloom filter with bloom filter bitmap 224.

On the other hand, when recipient list additions are received, bitmap updater module 249 can update an existing version of a bloom filter to include the additions (without requiring complete replacement of the bloom filter). For example, bitmap updater module 249 can create bitmap entries for each electronic mail address in recipient list additions 223 (using the same hash algorithms as bloom filter replacement module 242). Bitmap updater module 249 can insert the entries into bloom filter bitmap 224 to generate bitmap updater module 224u. Bitmap 224u includes an entry for each electronic mail address in electronic mail recipients list 221 as well as each electronic mail addresses in recipient list additions 223.

Alternately, recipient list additions can be replicated by creating bit map entries file server 202 and then replicating the entries to secondary data centers. At the secondary data centers, a bitmap updater module (e.g., similar to bitmap updater module 249) can then update appropriate entries in Bloom filter bitmap 224u.

From time to time, edge server 206 can receive electronic messages via SMTP from SMTP senders (e.g., other electronic mail providers). Upon receiving an electronic mail message, transport agent 251 can determine if provider 290 is responsible for any recipient electronic mail address included in the electronic mail message. To do so, transport agent 251 can utilize the same hash algorithms used by both bloom filter replacement module 242 and bitmap updater module 249 to generate bitmap locations values within bloom filter bitmap 224u. Transport agent 251 can determine if each generated bitmap location within bloom filter bitmap 224u is set ot an non-initialized value (e.g., to one).

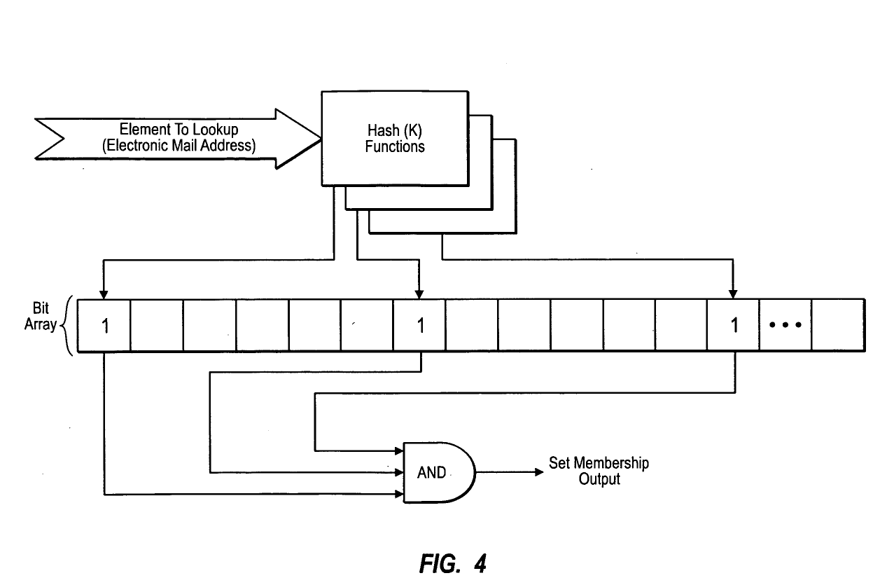

In some embodiments, transport agent 251 performs a logical “AND” of the values at each generated bit map location. For example, FIG. 4 depicts an example, of using a Bloom filter to check set membership. If the results of the logical “AND” is a zero, then provider 290 is not responsible for a received electronic mail address that was used to generate the bit map locations. On the other hand, if the results of the logical “AND” is a one, then provider 290 is responsible for a received electronic mail address that was used to generate the bit map locations.

When transport agent 290 detects responsibility for an electronic mail address, transport agent 290 can refer to customer settings & policy 222 to determine how to process the message that includes an electronic mail address. For example, transport agent 290 can refer the message to virus scanners, SPAM checking algorithms, checking current inbox storage allocations, etc. before forwarding the electronic message. When messages have been processed they can be sent to SMTP receivers 311 via SMTP, such as, for example, to an inbox for the electronic mail address.

On the other hand, when agent 290 detects that provider 290 is not responsible for any recipient electronic mail addresses in an electronic mail message, the electronic mail message can be dropped. This conserves the resources of edge server 308 by not performing additional processing on such electronic mail messages.

From the perspective provider 290, some rate of false positives may be acceptable when using a Bloom filter. For example, in a small number of cases, it may be acceptable to identify that provider 290 is responsible for a received electronic mail address when in fact it is not. In such a case, provider 290 may expend some resources on unnecessarily processing the message to check for viruses, SPAM, etc. However, this resource consumption can be viewed as an acceptable tradeoff based on the increased efficiency of checking received electronic mail addresses. Further, since bloom filters are essentially immune to false negatives, there is virtually no chance of a message bypassing further processing before being delivered to a valid account.

At scale, a Bloom filter bitmap suitable for lookups of on the order of 100,000,000 electronic mail addresses might be 512 Megabytes, and the bits representing each entry scattered in 30 different locations throughout the file. New set members are added sequentially to an auxiliary file (or data stream in an NTFS file), such as, for example, incremental updates 142 or recipient list additions 323, to rather than hashed. The concentrated (rather than distributed) nature of additions results in substantially better replication behavior.

Accordingly, embodiments of the invention facilitate more efficient use Bloom filters across multiple computers connected across a WAN (potentially having limited bandwidth and latency characteristics), such as, for example, computers located on different continents. The acceptability of false positives is leveraged by allowing the operation of removing items from the set to be batched and delayed. On the other hand, insert operations may be more latency sensitive as a delayed insert results in the semantic equivalent to a false negative. As such, additions are processed in closer to real time to update Bloom filters.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, the computer system and one or more other computer systems connected to a network, each computer system configured to determine set membership in a set using a bloom filter, the bloom filter representing resources that are members of the set, each computer system having access to a local copy of the bloom filter such that each computer system can individually determine set membership, a method for updating the bloom filter, the method comprising:
an act of receiving an update to the set, the set update changing membership in the set;
an act of determining that the set update is the insertion of a new resource into the set;
an act of supplementing the local version of the bloom filter at the computer system to represent insertion of the new resource; and
an act of sending data indicative of the set update to each of the one or more other computer systems separate from the bloom filter and before a new version of the bloom filter including the set update is generated, the set update for supplementing local versions of the bloom filter at the one or more other computer systems such that the one or more other computer systems can individually supplement their local versions of the bloom filter to represent insertion of the new resource without having to receive a new version of the bloom filter.

2. The method as recited in claim 1, wherein the act of receiving an update to the set comprises an act of receiving an addition to a list of electronic mail recipients for an electronic mail provider.

3. The method as recite in claim 1, wherein the local version of the bloom filter at the computer system is loaded in system memory of the computer system and wherein the act of supplementing the local version of the bloom filter comprises:
an act of generating one or more hash values for the set update, the hash values generated in accordance with hash algorithms of the bloom filter; and
an act of using the one or more hash values to update the local version of the bloom filter in system memory at the computer system.

4. The method as recited in claim 1, wherein the act of sending data indicative of the set update comprises:
an act of adding data indicative of the set update to a secondary file at the computer system; and
an act of replicating the secondary file to the one or more other computer systems

5. The method as recited in claim 1, wherein the act of sending data indicative of the set update comprises an act of sending a file stream that includes the data indicative of the set update, the file stream in a separate format from the bloom filter.

6. The method as recited in claim 1, wherein the act of sending data indicative of the set update comprises an act of sending the set update to the one or more other computer systems.

7. The method as recited in claim 1, wherein the act of sending data indicative of the set update comprises:
an act of generating one or more hash values for the set update, the hash values generated in accordance with hash algorithms of the bloom filter; and
an act of sending the one or more hash values to the one or more other computer systems.

8. The method as recited in claim 1, wherein the Bloom filter is a plurality of megabytes in size and the number of hash functions utilized is greater than twenty-five.

9. The method as recited in claim 1, wherein the computer system is a file server in a primary data center for an electronic mail provider and the one or more other computer systems are file servers in one or more secondary data centers for the electronic mail provider.

10. A networked computer system for determining set membership in a set, the networked computer system connected to one or more other computer systems, the one or more other computer systems having local versions of a bloom filter loaded into system memory, the networked computer system comprising:
one or more processors;
system memory;
a local version of the bloom filter loaded into system memory, the local version of the bloom filter representing resources that are members of the set;
one or more physical storage media having stored thereon computer-executable instructions representing a set updating module, the set updating module configured to:
receive updates to the set, set updates changing membership in the set;
determine when a set update represents insertion of a new resource into the set;
determine when a set update represents deletion of an existing resource from the set;
when a set update represents insertion of a new resource into the set:
supplement the local version of the bloom filter in system memory to represent that the new resource is a member of the set; and
send data indicative of the set update to each of the one or more other computer systems such that the one or more other computer systems can supplement their local versions of the bloom filter to represent that the new resource is a member of the set without having to receive a new version of the bloom filter, the sent data being sent separate from the bloom filter and before a new version of the bloom filter including the set update is generated; and
when a set update represents deletion of an existing resource of the set:
queue the set update for inclusion in a next version of the bloom filter that is generated.

11. The networked computer system of claim 10, wherein the Bloom filter representing resources that are members of the set comprises the Bloom filter represent electronic mail recipients that are the responsibility of an electronic mail provider.

12. The networked computer system of claim 10, wherein the Bloom filter representing resources that are members of the set comprises generating one or more hash values from hash algorithms for the bloom filter and inserting the hash values into a bit map.

13. The networked computer system of claim 10, wherein the set updating module configured to supplement the local version of the bloom filter in system memory comprises the set updating module being configured to:
generate one or more hash values for set updates, the hash values generated in accordance with hash algorithms of the bloom filter; and
use the one or more hash values to update the local version of the bloom filter in system memory at the networked computer system.

14. The networked computer system of claim 10, wherein the set updating module configured to send data indicative of the set update comprises the set updating module being configured to:
add data indicative of the set update to a secondary file at the computer system; and
replicate the secondary file to the one or more other computer systems

15. The networked computer system of claim 10, wherein the set updating module configured to send data indicative of the set update comprises the set updating module being configured to send a file stream that includes the data indicative of the set update, the file stream in a separate format from the bloom filter.

16. The networked computer system of claim 10, wherein the set updating module configured to send data indicative of the set update comprises the set updating module being configured to send the set update to the one or more other computer systems.

17. The networked computer system of claim 10, wherein the set updating module configured to send data indicative of the set update comprises the set updating module being configured to:
generate one or more hash values for the set update, the hash values generated in accordance with hash algorithms of the bloom filter; and
send the one or more hash values to the one or more other computer systems.

18. The networked computer system of claim 10, wherein queuing the set update for inclusion in a next version of the bloom filter that is generated comprises an act of storing an electronic mail recipient that is to be removed from a list of electronic mail recipients that an electronic mail provider is responsible for.

19. The method as recited in claim 19, wherein the Bloom filter is a plurality of megabytes in size.

20. At a computer system including one or more processors and system memory, the computer system and one or more other computer systems connected to a network, each computer system configured to determine if an electronic mail address included in an electronic mail message is the responsibility of an electronic mail provider prior to securely processing the electronic mail message, each computer system including a local version of a bloom filter that represents the recipient electronic mail addresses the provider is responsible for such that each computer system can individually determine if the provider is responsible for an electronic mail address, a method for updating the bloom filter, the method comprising:
an act of receiving an update directed to a database that stores electronic mail addresses the provider is responsible for, the update altering electronic mail addresses included in the database;
an act of determining that the update is the insertion of a new electronic mail addresses into the database;
an act of supplementing the local version of the bloom filter at the computer system to represent that the new electronic mail addresses is the providers responsibility;
an act of sending data indicative of the update to each of the one or more other computer systems separate from the bloom filter and before a new version of the bloom filter including the update is generated, the set update for supplementing local versions of the bloom filter at the one or more other computer systems such that the one or more other computer systems can individually supplement their local versions of the bloom filter to represent insertion of the new electronic mail address without having to receive a new version of the bloom filter.
